(19) United States
(12) Patent Application Publication
(10) Pub. No.: US 2016/0165382 A1
(43) Pub. Date: Jun. 9, 2016

(54) ELECTRONIC ENTITY FOR A MOBILE TERMINAL

(71) Applicant: Orange, Paris (FR)

(72) Inventors: David Picquenot, Authie (FR); Philippe Levionnais, Caen (FR)

(21) Appl. No.: 14/899,113

(22) PCT Filed: Jun. 27, 2014
(86) PCT No.: PCT/FR2014/051647

§ 371 Date: Feb. 16, 2016

(30) Foreign Application Priority Data
Jun. 28, 2013 (FR) 1356323

(51) Int. Cl. H04W 4/00; H04M 1/725; G06K 19/07; G06K 7/10

(52) U.S. Cl. CPC H04W 4/008; G06K 7/10297; H04M 1/7253; G06K 19/0727

(57) ABSTRACT

An electronic entity for a mobile terminal. The invention concerns an electronic entity (10) for a mobile terminal (20), said terminal being capable of receiving a subscriber identity card (30), said electronic entity comprising:
a near field communication device (11),
a wired interface (120) intended to connect the mobile terminal to the subscriber identity card at a first data interface (I/O₁) and the near field communication device to the subscriber identity card by means of a protocol link (SWP), characterised in that the wired interface is arranged to connect the mobile terminal to the near-field communication device at a second data interface (I/O₂).

The invention relates to the general field of telecommunications.

It concerns more particularly what are known as “contactless” communication technologies, such as near field communication technologies or NFC (from the English “Near field Communication”) technologies, and their use in mobile communication terminals for executing what are known as “contactless” applications.

Contactless applications based on NFC technologies are developed, by way of example, for electronic transactions in the banking field, in proximity payment or in public transport, or else for identification or access control applications.

In a general manner, in these so-called NFC applications, near field communication is set up between two contactless NFC entities: each NFC entity is, to this end, made up of a near field communication component (or NFC component) that has an associated antenna allowing contactless communication to be set up with the other NFC entity.

According to a first mode of operation, one of the NFC entities operates as a contactless card, while the other entity operates as a contactless card reader. Examples of contactless NFC entities operating according to such a mode of operation are an RFID (Radio Frequency IDentification) tag and an RFID tag reader. A “peer to peer” (or P2P) mode of operation is likewise known in which the contactless NFC entities play an equivalent role and operate as contactless cards interchanging data locally.

NFC applications are rapidly expanding at present and numerous services are installed in mobile terminals. Sensitive contactless applications are generally installed in the subscriber identity card with which the mobile terminal is equipped, because they require a certain level of security. These are payment applications, for example. However, at present, not all mobile terminals provide NFC functionalities.

In the present prior art, there are systems allowing provision of the functionalities of an NFC entity (i.e. of a contactless card and/or of a contactless card reader) for a mobile terminal equipped with a subscriber identity card, or “SIM” (“Subscriber Identity Module”) card, and combination of these NFC functionalities with the mobile telephone functionalities of the terminal.

The international application published under the number WO2011/148086 thus proposes a system allowing a mobile terminal initially not equipped for implementing NFC applications to be made NFC compatible. This system has an architecture in which an NFC device, comprising an NFC entity and an associated antenna, is connected by means of a wired interface to the mobile terminal at the SIM card only. By way of example, this wired interface is in the form of a plastic NFC sheet holding a plurality of linking wires within it in order to establish contact between the SIM card and the NFC component. In this architecture, the NFC device is placed inline between the mobile terminal and the SIM card as far as the supply of electric power is concerned and is connected solely to the SIM card for protocol exchanges by means of an “SWP” (from the English “Single Wire Protocol”) link.

Additionally, the international application published under the number WO2011/148087 describes a mobile terminal shell intended to be fixed against the rear face of a mobile terminal in a removable manner, instead of a shell that is provided initially with the mobile terminal, and comprising an NFC component and a wired interface that is put into contact with the SIM card of the mobile terminal when the shell is positioned at the rear of the mobile terminal. This shell is designed to receive and hold, on its internal surface, the NFC device and its associated antenna, and comprises a means such as a recess, for guiding the wired interface so as to connect the NFC device to the SIM card.

This architecture and this shell thus allow adaptation of an existing mobile telephone that does not initially have NFC functionalities so as to allow it to provide NFC functionalities.

Such a design has a few limitations, however. The reason is that, with such an architecture, NFC applications must be systematically factory preinstalled in the SIM card with which the NFC component communicates by means of the SWP link. Moreover, the NFC applications installed in the SIM card require specific programming interfaces that absolutely must be preinstalled. Thus, it is not possible to download NFC applications to the SIM card once the SIM card has been put into circulation; an application must be installed beforehand, during a configuration phase, for example in the factory, so as to make the necessary adaptations. It will be understood that such operation is highly restrictive for the deployment of new NFC applications, whereas this field is rapidly expanding.

One of the aims of the invention is to overcome inadequacies/disadvantages of the prior art and/or to make improvements thereto.

To this end, the invention proposes an electronic entity for a mobile terminal, said terminal being capable of receiving a subscriber identity card, said electronic entity comprising:
a near field communication device,
a wired interface that is designed to connect the mobile terminal to the near field communication device at a first data interface by means of a processing unit, the processing unit being placed inline on the data transmission path between the mobile terminal and the subscriber identity card and placed inline on the data transmission path between the mobile terminal and the near field communication device.

Thus, the electronic entity makes it possible to provide NFC functionalities for a mobile terminal initially not equipped to provide this kind of functionality. The near field communication device can converse with the mobile terminal. Thus, it becomes possible to download new NFC applications to the mobile terminal, once the latter has been put into circulation. The reason is that the NFC applications no longer require installation in the subscriber identity card and specific developments that made a posteriori installation impossible. Owing to this new mode of operation, the cost of NFC application deployments decreases, which can play a part in the deployment of new NFC applications.

Moreover, the invention proposes an electronic entity for a mobile terminal, said terminal being capable of receiving a subscriber identity card, said electronic entity comprising:
a near field communication device,
a wired interface intended to connect the mobile terminal to the subscriber identity card at a second data interface and the near field communication device to the subscriber identity card by means of a protocol link, said wired interface being designed to connect the mobile terminal to the near field communication device at the first data interface.

The electronic entity allows NFC functionalities to be provided for a mobile terminal initially not equipped to provide this kind of functionality. This entity is compared to the electronic entity described in the application WO2011/148086 and is of interest in many respects. With the electronic entity according to the invention, the near field communication device is no longer solely connected to the subscriber identity card and can converse with the mobile terminal. Thus, it becomes possible to download new NFC applications to the mobile terminal, once the latter has been put into circulation. The reason is that the NFC applications no longer require installation in the subscriber identity card and specific developments that made a posteriori installation impossible. Owing to this new mode of operation, the cost of NFC application deployments decreases, which can play a part in the deployment of new NFC applications.

Moreover, it is no longer necessary to preinstall specific programming interfaces in the subscriber identity card. With this new mode of operation, where NFC applications are installed in the mobile terminal, normalized interfaces will be used. It will therefore no longer be necessary to provide specific interfaces.

Moreover, direct transmission from the mobile terminal to the near field communication device is faster than when these commands are transmitted via the subscriber identity card. It likewise allows data of greater size to be read.

Direct communication between the mobile terminal and the near field communication device likewise allows the display of information relating to an NFC transaction to be facilitated. The reason is that the display of a piece of information relating to a transaction is no longer restricted by a “polling” mechanism implemented by the mobile terminal in order to ask the subscriber identity card if it wishes to display a message for the attention of the user following an NFC transaction.

This architecture likewise allows the mobile terminal to supervise the near field communication device. Thus, the mobile terminal can send commands to the near field communication device, for example a reset command when said near field communication device is in an abnormal state for a given time.

Moreover, this architecture allows the mobile terminal to instruct the near field communication device to change to a standby state, which helps to improve the longevity of the battery of the terminal.

In one exemplary embodiment, the wired interface of the electronic entity is designed to connect the mobile terminal to the subscriber identity card at the first interface by means of a processing unit, the processing unit being placed inline on the data transmission path between the mobile terminal and the subscriber identity card and placed inline on the data transmission path between the mobile terminal and the near field communication device, said processing unit being designed to organize at least the data transmitted between the mobile terminal and the subscriber identity card by the first and second data interfaces.

The processing unit is thus placed inline on the data transmission path between the mobile terminal and the subscriber identity card. This architecture allows the installation of applications in the subscriber identity card from the first interface of the mobile terminal. Some mobile terminals are not adapted to implement OTA download of applications and require the applications intended to be executed by the subscriber identity card to be preinstalled. Owing to the electronic entity, an application that is intended to be installed in the subscriber identity card can be received by the mobile terminal and transmitted via the first interface of the mobile terminal to the subscriber identity card.

The electronic entity manages priorities in the transmission of the data that are received by the various interfaces. More precisely, the processing unit is capable of determining which data needs to be transmitted with priority. This functionality is indispensable because data that are intended for the subscriber identity card can arrive on two different interfaces.

In one exemplary embodiment of the invention, the transmission of the data is organized according to an organization criterion.

The processing unit is adapted to organize the transmission of the data according to a given criterion.

According to one exemplary embodiment, the wired interface is adapted to connect an input/output contact of the mobile terminal to the processing unit, and the processing unit to an input/output contact of the subscriber identity card, so that any datum transmitted between the mobile terminal and the subscriber identity card on the second data interface is received by the processing unit.

The processing unit is thus placed inline on the data transmission path between the mobile terminal and the subscriber identity card owing to the wired interface that diverts the input/output connection between the mobile terminal and the subscriber identity card at the contacts C7_TM of the mobile terminal and C7_SIM of the subscriber identity card.

In one exemplary embodiment, the wired interface is adapted to connect the processing unit to a connector of the mobile terminal that comprises the first data interface and to the near field communication device, so that any datum transmitted between the near field communication device and the mobile terminal is received by the processing unit.

The first interface of the mobile terminal corresponds to a connector that is adapted to connect the mobile terminal to a docking station. This connector makes it possible to obtain a data link in order to communicate with the NFC device by means of the processing unit.

According to one exemplary embodiment of the invention, the wired interface connects the subscriber identity card to the near field communication device by means of a protocol link.

A protocol link is defined between the subscriber identity card and the near field communication device. Thus, NFC applications that require a high level of security, such as payment applications, can be installed in the subscriber identity card and communicate with the device when the NFC applications are executed.

In one exemplary embodiment, the data are organized according to a code prefixing a datum transmitted between the mobile terminal and the subscriber identity card.

According to this example, fine analysis of the data is implemented by the processing unit that decides, on the basis of the code prefixing these data, the order in which the data need to be forwarded.

According to another exemplary embodiment, the processing unit of the electronic entity is designed to suspend a transmission of data between the mobile terminal and the subscriber identity card by the first interface on reception of a datum from the mobile terminal for the subscriber identity card on the second interface.

In this example, the processing unit forwards as a matter of priority the data exchanged between the subscriber identity card and the mobile terminal through the contacts C1_TM to C8_TM and C1_SIM to C8_SIM of the terminal and of the card.

Advantageously, the wired interface comprises direct connection means between an electric power supply output of the mobile terminal and an electric power supply input of the near field communication device.

The electronic entity is designed so that the near field communication device is supplied with electric power directly by the mobile terminal. Thus, the near field communication device has all the power that the terminal has. The performance of the near field communication device is thus improved because, when a tag is read by the mobile terminal, more precisely by the field communication device, the tag can be further away from the antenna in order to be read than in the architecture described in the application WO2011/148086.

The invention also concerns a mobile terminal that is designed to receive a subscriber identity card and comprises an electronic entity as described previously.

The invention likewise relates to a shell for a mobile terminal, the terminal being capable of receiving a subscriber identity card, the mobile terminal comprising a front face having a user interface and a rear face, said shell comprising an internal surface and an external surface and being adapted to receive the mobile terminal in removable fashion such that the rear face of the mobile terminal is held along the internal surface of the shell, the internal surface of the shell comprising means for holding an electronic entity as described previously.

The invention also concerns a method for managing a transmission of data between a mobile terminal that is capable of receiving a subscriber identity card and the subscriber identity card, and between the mobile terminal and a near field communication device, the near field communication device being included in an electronic entity as claimed in one of claims 1 to 9, said entity being interfaced with the mobile terminal and the subscriber identity card, said method comprising:
a step of reception of first data on a first data interface,
a step of reception of second data on a second data interface,
a step of prioritization of the transmission of said first and second data according to an organization criterion,
a step of transmission of said first and second data, according to the defined organization.

The invention also relates to a program on a data storage medium and that can be loaded into a memory of an electronic entity, the program comprising code portions for executing the steps of the method for managing a transmission of data as described previously.

The invention likewise concerns a data storage medium on which the program described above is recorded.

Other features and advantages of the present invention will be better understood from the description and the appended drawings, among which:

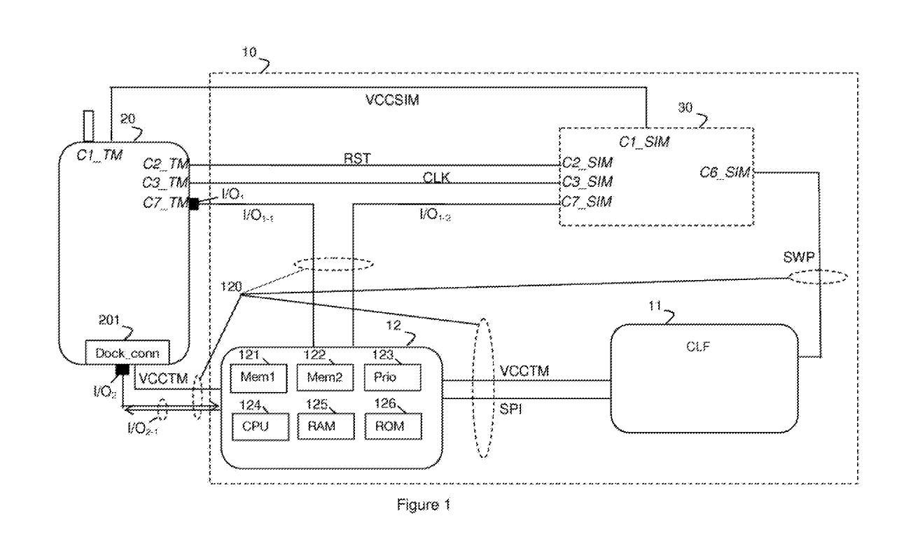

FIG. 1 shows an architecture in which an electronic entity is interfaced with a mobile terminal and a subscriber identity card, according to an exemplary embodiment of the invention;

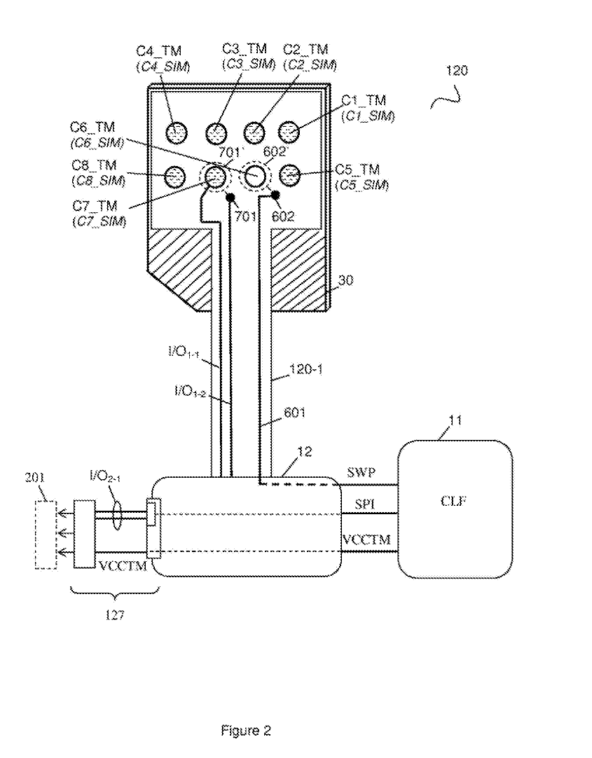

FIG. 2 shows an example of a wired interface that is adapted to connect the electronic entity to the mobile terminal and to the subscriber identity card;

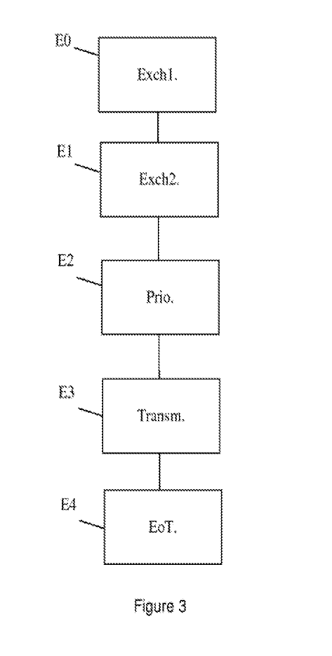

FIG. 3 shows the steps of a method for processing messages transiting between the mobile terminal and the subscriber identity card, on the one hand, and between the mobile terminal and the NFC device, on the other hand, as implemented by an electronic entity according to the invention, according to an exemplary embodiment of the invention.

An electronic entity 10, according to an exemplary embodiment of the invention, will now be described with reference to FIG. 1.

An electronic entity 10 according to the invention is designed to interface with a mobile terminal 20. It is presupposed that initially the mobile terminal 20 is not adapted to implement NFC applications. The interfacing with the electronic entity 10 is intended to make the mobile terminal 20 NFC compatible, that is to say to allow it to implement NFC applications. By way of example, the mobile terminal 20 is a smart mobile terminal of smartphone type, such as an iPhone®. The mobile terminal 20 is designed to accommodate a security module of “UICC” (“Universal Integrated Circuit Card”) card type. An example of such a card is a subscriber identity card 30, or “(U)SIM” (“(Universal) Subscriber Identity Module”) card, as used in mobile telephony. To facilitate reading of the architecture that is presented with reference to FIG. 1, the subscriber identity card 30 is shown outside the mobile terminal 20. The subscriber identity card 30 is not part of the electronic entity 10 and to that end is shown in dotted lines.

The mobile terminal 20 is likewise equipped with a first connector 201 to a docking station (not shown in FIG. 1), which is usually denoted “dock connector”, or “iDock Lightening®” in a recent version of iPhone®. The first connector 201 to the docking station is intended, by way of example, to recharge the battery of the mobile terminal 20 from the mains when the mobile terminal 20 is connected to the docking station by means of this connector, to interface with other pieces of equipment (not shown in FIG. 1) such as a loudspeaker, in order to listen to music stored in memory in the mobile terminal 20. The first connector 201 is a socket comprising a plurality of pins, or connections, that are dedicated to specific functions, such as a function for the supply of electric power from a battery of the mobile terminal, a function for interchanging data with another device, etc.

The subscriber identity card 30 is fitted with a plurality of contact pads, among which the pads called VCC_{SIM}, GND_{SIM}, RST_{SIM}, CLK_{SIM} and I/O_{SIM} (not shown in FIG. 1) here may be cited, the respective function of which is to ensure that the card is supplied with electric current, is grounded, is reset, the input of a clock signal and the input and the output of data. These pads are electrically connected to contacts denoted C1_SIM to C8_SIM here that are flush with the surface of the card (not all the contacts are shown in FIG. 1). The pad VCC_{SIM} is thus connected to a contact C1_SIM, the pad GND_{SIM} is connected to a contact C5_SIM, the pad RST_{SIM} is connected to a contact C2_SIM, the pad CLK_{SIM} is connected to a contact C3_SIM and the pad I/O_{SIM} is connected to a contact C7_SIM. Contacts of the mobile terminal 20 that are C1_TM to C8_TM here (not all are shown in FIG. 1) are usually intended to be connected to the corresponding contacts of the subscriber identity card 30.

The electronic entity 10 according to the invention comprises:
an NFC device 11, denoted “CLF” (from the English “ContactLess Frontend”), that comprises a near field communication component (or NFC component) that has an associated antenna allowing contactless communication to be set up with another NFC entity (the NFC component and the antenna are not shown in FIG. 1). An NFC device and NFC technology are referred to here, and the invention can of course apply to other near field communication technologies. The NFC device 11 is designed to be connected to the subscriber identity card 30, by means of a protocol link, for example an “SWP” (from the English “Single Wire Protocol”) link. It is likewise designed to be connected to a processing unit 12 in order to receive a supply of electric power from the mobile terminal 12 on a VCCTM link, and in order to interchange data with the mobile terminal 20 on an SPI link, via the processing unit 12;
the processing unit 12, which is intended to manage data interchanges between the mobile terminal 20 and the subscriber identity card 30 through a first data interface I/O₁ of the mobile terminal 20, which first data interface is situated at the contact C7_TM, and through a second data interface I/O₂ of the mobile terminal 20, which second data interface is situated at the first connector 201 of the mobile terminal 20. The processing unit 12 is likewise intended to manage data interchanges between the mobile terminal 20 and the NFC device 11 through the second interface I/O₂. The first interface I/O₁ allows conversation with the subscriber identity card by means of a first data link I/O₁₋₁ and a second data link I/O₁₋₂. The second interface I/O₂ allows the mobile terminal 20 to converse with the subscriber identity card 30 by means of a third data link I/O₂₋₁ and the second data link I/O₁₋₂. The second interface I/O₂ allows the mobile terminal 20 to converse with the NFC device 11 by means of the third data link I/O₂₋₁ and a communication bus “SPI” (from the English “Serial Peripheral Interface”). The processing unit 12 is placed inline on the data transmission path between the mobile terminal 20 and the subscriber identity card 30. It is likewise placed inline on the data transmission path of data between the mobile terminal 20 and the NFC device 11. Thus, all the data that transit through the first data interface I/O₁ between the mobile terminal 20 and the subscriber identity card 30 pass through the processing unit 12. Equally, all the data that transit through the second data interface I/O₂ between the mobile terminal 20 and the NFC device 11, or between the mobile terminal 20 and the subscriber identity card 30, pass through the processing unit 12. The processing unit 12 is designed to prioritize the transmission of the data between the mobile terminal 20 and the subscriber identity card 30 when these data transit through the first data interface I/O₁ and/or the second data interface I/O₂, and between the mobile terminal 20 and the NFC device 11. It comprises:
first memory storage means 121, which are designed to store in memory data that transit through the first data interface I/O₁ and that originate from the mobile terminal 20 and are intended for the subscriber identity card 30, or originate from the subscriber identity card 30 and are intended for the mobile terminal 20,
second memory storage means 122, which are designed to store in memory data that transit through the second data interface I/O₂ and that originate from the mobile terminal 20 and are intended for the NFC device 11 or the subscriber identity card 30, or originate from the NFC device 11 or the subscriber identity card 30 and are intended for the mobile terminal 20,
prioritization and transmission means 123, which are designed to prioritize the transmission of data that are stored in the first and second memory storage means 121, 122, according to an organization criterion. Thus, the prioritization and transmission means 123 are designed to manage the transmission of three types of data: the data that transit between the mobile terminal 20 and the subscriber identity card through the first data interface I/O₁, the data that transit between the mobile terminal 20 and the subscriber identity card through the second data interface I/O₂ and the data that transit between the mobile terminal and the NFC device 11 through the second data interface I/O₂;
a microprocessor 124, or “CPU” (from the English “Central Processing Unit”), that is intended to load instructions into memory, to execute them, to perform operations;
a set of memories, including a volatile memory 125, or “RAM” (for “Random Access Memory”), which is used to execute code instructions, store variables, etc., and a storage memory 126 of “EEPROM” (from the English “Electrically Erasable Programmable Read Only Memory”) type. The storage memory 126 is designed to store in memory an application according to the invention that comprises code instructions that are intended to prioritize the transmission of data between the mobile terminal 20 and the subscriber identity card 30 through the first and second data interfaces I/O₁, and I/O₂, and between the mobile terminal 20 and the NFC device 11 through the second interface I/O₂, according to an organization criterion.

The electronic entity 10 likewise comprises a wired interface 120 that groups a plurality of linking wires within it. The wired interface 120 is intended to connect the mobile terminal 20, the subscriber identity card 30, the NFC device 11 and the processing unit 12. This wired interface comprises:
first power supply means, denoted VCCSIM, that are designed to connect the contacts C1_SIM of the subscriber identity card 30 and C1_TM of the mobile terminal 20. The first power supply means VCCSIM allow the mobile terminal 20 to supply electric power to the subscriber identity card 30,
second power supply means, denoted VCCTM, that are designed to supply electric power directly to the NFC component 11 and the processing unit 12 from the mobile terminal 20,
reset means, denoted RST, that are designed to connect the contacts C2_SIM of the subscriber identity card 30 and C2_TM of the mobile terminal 20. The reset means RST are intended to command resetting of the subscriber identity card 30 from the mobile terminal 20,
means for sending a clock signal, denoted CLK, that are designed to connect the contacts C3_SIM of the subscriber identity card 30 and C3_TM of the mobile terminal 20. The means for sending the clock signal CLK allow the mobile terminal 20 to provide a clock signal for the subscriber identity card 30,
a protocol link, denoted SWP, that is designed to connect the contact C6_SIM of the subscriber identity card 30 to the NFC device 11. This protocol link allows data to be interchanged according to a communication protocol, in this case SWP,
the first data link I/O₁₋₁ and the second data link I/O₁₋₂, which are intended to connect the pads C7_TM of the mobile terminal 20 and C7_SIM of the subscriber identity card 30. The processing unit 12 is placed inline on this first link. In other words, all the data that flow between the mobile terminal 20 and the subscriber identity card 30 pass through the processing unit 12,
the third data link I/O₂₋₁, which is intended to allow the transmission of data between the mobile terminal 20 and the NFC device 11 and between the mobile terminal 20 and the subscriber identity card 30, by means of the first connector 201. The second input/output link I/O₂ is represented by two unidirectional wires. The processing unit 12 is placed inline on this second link. In other words, all the data that flow between the mobile terminal 20 and the NFC device 11 pass through the processing unit 12.

For reasons of legibility, other links, such as ground, are not shown.

According to this architecture, it is firstly possible to access the subscriber identity card 30 through the second interface I/O₂ and, secondly, to prioritize the transmission of data between the terminal 20 and the subscriber identity card 30, depending on whether these data are transmitted by the first data interface I/O₁ or by the second interface I/O₂. The possibility of accessing the subscriber identity card 30 through the second data interface I/O₂, that is to say from the first connector 201, is of interest for the implementation of remote download of applications to the subscriber identity card 30. The reason for this is that it is known practice to download an application to a subscriber identity card using an “OTA” (from the English “Over The Air”) procedure. An application is thus received by the mobile terminal on the radio channel and then transmitted to the subscriber identity card by the mobile terminal through the contacts C7_TM of the mobile terminal and C7_SIM of the subscriber identity card. Most mobile terminals implement a bearer independent protocol, or “BIP” (from the English “Bearer Independent Protocol”) protocol, in order to facilitate such a download. The reason is that, with this protocol, operations between the mobile terminal and an application server are performed using end-to-end IP. When the mobile terminal does not implement the BIP protocol, an application is downloaded to the subscriber identity card on a byte-by-byte basis. It will be understood that, for an application with several thousand bytes, download is impossible, the link between the mobile terminal and the subscriber identity card not being able to be monopolized for a long time. In this case, the applications have to be installed on the subscriber identity card before it is put into circulation. The invention overcomes this problem and allows OTA download of applications to mobile terminals that do not implement the BIP protocol. With the electronic entity 10 described previously, an application can thus be downloaded using an OTA procedure after the subscriber identity card 30 has been put into circulation. The mobile terminal 20 that receives an application through the radio channel commands the installation of said application on the identity card 30 through the second interface I/O₂. The processing unit 12 can send the application to the subscriber identity card 30 via the second data link I/O₁₋₂ that connects the processing unit 12 to the subscriber identity card 30. This sending is not restricted by byte-by-byte transmission and can be performed by data packet. The download is thus faster than using the known method.

Moreover, the processing unit 12 is capable of prioritizing the data to be transmitted. Thus, when an application is downloaded, if a datum is received from the mobile terminal 20 through the first data interface I/O₁ for the attention of the subscriber identity card 30, and this datum needs to be transmitted to the subscriber identity card 30 as a matter of priority, then the processing unit 12 interrupts the transmission of the application to the subscriber identity card 30 that is in progress in order to immediately transmit the datum received from the mobile terminal 20 through the first data interface I/O₁. By way of example, a priority datum is a request from the mobile terminal 20 to the subscriber identity card 30 to know the state of the network. Once the priority datum, and if need be the response, has been transmitted, the processing unit 12 resumes the download of the application that was in progress.

On the basis of the architecture according to the invention, the NFC device 11 can converse, by means of the processing unit 12, with the mobile terminal 20. The NFC device 11 is therefore no longer solely accessible from the subscriber identity card 30, via the SWP interface, in accordance with the architecture proposed in the international application published under the number WO2011/148086. This possibility of conversation between the mobile terminal 20 and the NFC device 11, independently of the subscriber identity card 30, is advantageous. According to the architecture described in the application WO2011/148086, all NFC transactions go through the subscriber identity card, that is to say that any NFC application must be installed in the subscriber identity card, which is responsible for the opening of ports in the NFC device. Now, tag reading applications are not normalized, which implies specific developments for the subscriber identity card. This constraint prohibits remote download of NFC applications after the subscriber identity card has been put into circulation.

With the new architecture presented with reference to FIG. 1, it becomes possible to download new NFC applications to the mobile terminal 20, once the latter has been put into circulation. The NFC applications in question do not require a high level of security and therefore do not necessarily need to be installed in a secure environment. The NFC applications downloaded in this manner therefore do not require development that is specific to the subscriber identity card 30. Moreover, the cost of NFC application developments decreases, which can play a part in the deployment of new NFC applications. It will be understood that, in this embodiment, only the second interface may be present in the wired interface.

Moreover, direct transmission from the mobile terminal 20 to the NFC device 11 of commands linked to these NFC applications is faster than when these commands are transmitted via the subscriber identity card 30. It likewise allows data of greater size to be read. The reason is that communication via the subscriber identity card 30 is restricted by a predefined interface compliant with the recommendation ISO 7816. This interface is of limited capacity in terms of data size.

Direct communication between the mobile terminal 20 and the NFC device 11 likewise allows the display of information relating to an NFC transaction to be facilitated. The reason is that, with the architecture presented in the application WO2011/148086, a piece of information is displayed, following an NFC transaction, in compliance with a mode of communication between the mobile terminal and the subscriber identity card. In this mode, in compliance with the specification GSM 11.14 relating to the SIM application toolkit, the mobile terminal interrogates the subscriber identity card at regular intervals to find out whether it wishes to display a message for the attention of the user (the English term “polling” is usually used to denote this mode of interrogation). This interval of time is set by each network operator that manages subscriber identity cards and is of the order of several seconds. This gives rise to a delay between an end of an NFC transaction and the display of an information message to the user. This latency can be perceived as negative by the user. With the architecture according to the invention, the NFC device 11 informs the mobile terminal 20 directly that a message relating to an NFC transaction needs to be displayed. The message can thus be displayed without delay. This improves the ergonomics of the NFC applications.

The architecture likewise has advantages in terms of performance of the NFC device 11. The reason is that, with the architecture described in the application WO2011/148086, the NFC device is placed inline as far as the supply of electric power is concerned between the mobile terminal and the subscriber identity card. Thus, it is the NFC device that supplies power to the subscriber identity card from a power supply voltage that it receives from the mobile terminal. This architecture limits the intensity that the NFC device can receive to 50 mA, and any overconsumption cuts the tie between the mobile terminal and the subscriber identity card. With the architecture according to the invention, the subscriber identity card 30 is supplied with power in conventional fashion, that is to say directly from the mobile terminal 20, and the NFC device 11, which is supplied with electric power by the mobile terminal 20 via the first connector 201, has a higher power, the power with which the mobile terminal 20 is likely to provide it directly. The reading of a tag by the NFC device 11 is therefore facilitated. In particular, the coupling between the antenna of the NFC device 11 and the tag no longer needs to be as tight, and the tag can be further away from the antenna in order to be read.

The direct communication between the mobile terminal 20 and the NFC device 11 is likewise advantageous in the event of the NFC device 11 malfunctioning. The reason is that the NFC device 11 may come to be in a state of awaiting reception of a piece of information from a tag, whereas there is no tag in proximity. It is therefore likely to remain in this state for an indeterminate period. This is an abnormal state. With the architecture described in the application WO2011/148086, it is not possible to supervise such a state and to introduce time delays in order to reset the NFC device when it remains in this state indefinitely. The reason is that the interchanges between the subscriber identity card and the NFC device are restricted by the SWP link, which does not provide any means for such supervision. With the architecture according to the invention, the mobile terminal 20 can manage the arming of a time delay when it is awaiting a response from the NFC device 11. Thus, the mobile terminal 20 can command a reset for the NFC device 11 when the latter does not respond at the end of a determined time. The reliability of the NFC device 11 is therefore improved.

The direct communication between the mobile terminal 20 and the NFC device 11 is likewise advantageous in terms of management of the battery of the mobile terminal 20, in relation to the architecture proposed in the application WO2011/148086. The reason is that conventionally the NFC device, which can read or be read, depending on whether it operates in card reader mode or in card emulator mode, alternates a reader mode for a first determined period, during which it transmits in order to read tags that would be in radio range, and a card emulator mode. The reader mode requires a high power. After the first determined period, the NFC device changes to the card emulator mode for a second determined period, during which it can be read by a reader. In the card emulator mode, the power consumption is very low. At the end of the second determined period, it returns to reader mode. With the architecture described in the application WO2011/148086, the NFC device alternates these two modes continuously; there is actually no way of changing the NFC device to standby mode because, by going through the subscriber identity card, it is not possible to detect the change to standby mode for the mobile terminal. With the architecture according to the invention, when the mobile terminal 20 changes to standby, that is to say when its screen turns off, it can send a command to the NFC device 11 so that the latter likewise changes to standby and stops alternating the card reader and emulator modes. Thus, the NFC device 11 no longer consumes anything when the mobile terminal 20 changes to standby. This affects the longevity of the battery. Equally, when the mobile terminal 20 exits the standby mode, it can send a command to the NFC device 11 in order to wake it so that it alternates the card reader and emulator modes again.

The electronic entity 10 is described here as an entity that is adapted to interfacing with a mobile terminal that initially is not equipped for NFC. The invention is not limited to this scenario. Thus, in another example of use, the electronic entity 10 interfaces with a mobile terminal that is equipped for NFC and that stores applications in memory in the mobile terminal. Initially, this terminal is therefore not adapted for NFC applications that would be stored in the subscriber identity card. The electronic entity 10 described previously can be used in order to complement the NFC functionalities of a mobile terminal and to provide the latter with ways of installing NFC applications in the mobile terminal and in the subscriber identity card. The latter possibility is adapted to applications that require a high level of security.

An exemplary embodiment of a wired interface 120, which is intended to interface the mobile terminal 20, the subscriber identity card 30, the NFC device 11 and the electronic entity 10, according to an exemplary embodiment, will now be described with reference to FIG. 2.

This exemplary embodiment is inspired by means for linking the mobile terminal and its subscriber identity card to an electronic entity that are described in the application WO2011/148086.

In the exemplary embodiment described here, the wired interface 120 comprises an interface in the form of a sheet 120-1, which may correspond to a supple plastic film, that comprises a plurality of linking wires within it.

The subscriber identity card 30 is hatched and the portion of the wired interface 120-1 that is intended to interface the processing unit 12 with the subscriber identity card 30 and the mobile terminal 20 (not shown in FIG. 2) comes to be positioned on the subscriber identity card 30. It is represented in white.

The mobile terminal 20 is adapted to be positioned on the sheet 120-1 (it is not shown in FIG. 2, for reasons of legibility). Contacts C1_TM to C8_TM of the mobile terminal (with dashes in FIG. 2) are intended to be connected to the corresponding contacts of the subscriber identity card 30. The corresponding contacts of the subscriber identity card, which are denoted C1_ SIM to C8_SIM, are positioned beneath the sheet, opposite the contacts of the mobile terminal 20, and they are therefore not visible.

The contacts C1_TM, C2_TM, C3_TM and C5_TM respectively to the supply of electric power for the mobile terminal 20, to the resetting of the subscriber identity card 30 from the mobile terminal 20, to the clock signal and to ground. The contacts C4_TM and C8_TM are reserved for future use according to the recommendation ISO 7816. In this exemplary embodiment, the contacts C1_TM, C2_TM, C3_TM, C5_TM, C4_TM and C8_TM are intended to be connected to the corresponding contacts of the subscriber identity card 30. To this end, the sheet that is positioned between the subscriber identity card 30 and the mobile terminal 20 comprises holes at these contacts, which makes it possible to ensure contact between the contacts of the subscriber identity card 30 and the corresponding contacts of the mobile terminal 20.

The contact C6_TM corresponds to a contact of the mobile terminal 20 that is usually intended to be connected to a corresponding contact C6_SIM of the subscriber identity card 30 in order to allow data interchange according to a communication protocol, for example the SWP protocol. In the embodiment described here, provision is made for the NFC device 11 to be connected to the subscriber identity card only, at the corresponding contact C6_SIM of the subscriber identity card 20. To this end, provision is made for the contact C6_TM of the mobile terminal 20 to be isolated from the corresponding contact C6_SIM of the subscriber identity card 30. A two-way link 601 for the sheet 120-1 then matches the corresponding contact C6_SIM of the subscriber identity card 30 to the NFC device 11. To this end, a conductive pad 602 passing through the sheet 120-1 allows protocol exchanges to be forwarded from the NFC device 11 to the upper face of the sheet 120-1. A metal connection 602′ on the lower face of the sheet 120-1, between the pad 602 and the contact C6_SIM of the subscriber identity card 30, allows the protocol exchanges to be forwarded to the subscriber identity card 30. This metal connection 602′ situated on the lower face of the sheet is shown in dotted lines. Thus, a connection is set up between the contact C6_SIM of the subscriber identity card 30 and the NFC device 11 by means of the pad 602, the connection 602′ and the two-way link 601.

The contact C7_TM corresponds to a contact of the mobile terminal 20 that is usually intended to be connected to the corresponding contact C7_SIM of the subscriber identity card 30 in order to manage input/output streams of data between the mobile terminal 20 and the subscriber identity card 30. In the embodiment of the present invention, provision is made for the processing unit 12 to be placed inline on the data interchange path between the subscriber identity card 30 and the mobile terminal 20. To this end, the input/output contact C7_TM of the mobile terminal 20 is isolated from the corresponding contact C7_SIM of the subscriber identity card 30, so as to be able to place the processing unit 12 inline on the data path between the mobile terminal 20 and the subscriber identity card 30. The contact C7_TM of the mobile terminal is firstly isolated from the corresponding contact C7_SIM of the subscriber identity card 30 and secondly connected to the processing unit 12 by means of the first two-way input/output link I/O₁₋₁ The second data link I/O₁₋₂ is connected to a pad 701 that passes through the sheet 120-1, thus allowing the sheet 120-1 to be passed through from the upper face to the lower face. A metal connection 701′ (shown in dotted lines in FIG. 2, because it is situated on the face of the sheet that is not visible) on the lower face of the sheet 120-1, between the pad 701 and the corresponding contact C7_SIM of the subscriber identity card 30, then allows the transmission of data between the processing unit 12 and the subscriber identity card 30. Thus, the contact C7_TM is isolated from the corresponding contact C7_SIM of the subscriber identity card, and the data that transit between the mobile terminal 20 and the subscriber identity card 30 pass through the processing unit 12.

The wired interface 120 is likewise adapted to connect the processing unit 12 to the NFC device 11, as described with reference to FIG. 1. Thus, a two-way link in the form of the SPI bus connects the processing unit 12 to the NFC device 11 and allows the interchange of data between the mobile terminal 20 and the NFC device 11 via the processing unit 12. All the data that transit between the mobile terminal 20 and the NFC device 11 pass through the processing unit 12. The second electric power supply link VCCTM allows the supply of electric power to the NFC device 11 from the mobile terminal 20 via the processing unit 12.

The wired interface 120 is likewise adapted to connect the processing unit 12 and the mobile terminal 20. To this end, a second connector 127 is provided that is adapted to connect the processing unit 12 to the first connector 201 (shown in dotted lines in FIG. 2) of the mobile terminal 20. This second connector 127 allows the supply of electric power for the mobile terminal 20 to be recovered and to be transmitted to the NFC device 11. It likewise allows connection to the second interface I/O₂, via the third data link I/O₂₋₁. The processing unit 12 is thus adapted to transmit the data between the mobile terminal 20 and the NFC component 11 using a transmission of data method according to the invention.

There is no prejudice to the forms that the wired interface 120 can take. The portion that connects the processing unit 12 to the subscriber identity card 30 and to the mobile terminal 20 can take the form of the plastic sheet 120-1 as described previously. The plastic sheet 120-1 can comprise the connection between the processing unit 12 and the NFC device 11. In another exemplary embodiment, the processing unit 12 and the NFC device 11 can be connected by means of a rigid tie. The connection between the mobile terminal 20 and the processing unit 12 can likewise take various forms. In one exemplary embodiment, the second connector 127 is removable and capable of having a first end connected to the first connector 201 of the mobile terminal and having a second end connected to a third connector (not shown) included in the processing unit 12. In another exemplary embodiment, the second connector 127 comprises a first free end, which is capable of connecting to the first connector 201 of the mobile terminal 20, and a second end, which is fixed to the processing unit 12 by known fixing means.

The invention likewise concerns a shell (not shown) for a mobile terminal that is capable of comprising a subscriber identity card. The mobile terminal comprises a front face exhibiting a user interface and a rear face. The shell has an internal surface and an external surface. This shell has a form that is adapted to receiving the mobile terminal in a removable manner so that the rear face of the mobile terminal comes to be positioned against the internal surface of the shell and is held along this internal surface. The internal surface of the shell is adapted to holding the electronic entity 10 according to the invention. In comparable fashion to the shell described in the application published under the number WO2011/148087, the shell can comprise means for guiding the wired interface 120 between the various entities, in this case the processing entity 12, the NFC device 11, the subscriber identity card 30 and the mobile terminal 20. The shell may be rigid, or supple so as to facilitate the positioning of the mobile terminal 20. In the exemplary embodiment in which the shell is rigid, it can comprise two portions, a first portion intended to provide for the connection of the wired interface 10 to the mobile terminal via the connector 201, and a second portion intended to provide for the connection of the wired interface 10 to the mobile terminal 20 at the contacts C1_TM to C8_TM. The two portions can fit together once the mobile terminal 20 is in place, so that they are held in place.

In one exemplary embodiment, the wired interface 120, and more precisely the sheet 120-1, is adapted to interfacing with the subscriber identity card 30 and the mobile terminal 20 in accordance with what is described in the application WO2011/1480087. In this example, the sheet 120-1 and the subscriber identity card 30 are inserted into a slot in the mobile terminal that is usually provided for the purpose of accommodating the subscriber identity card 30. The invention is not limited to this example and, in another exemplary embodiment, the contacts C1_TM to C8_TM of the mobile terminal 20 are relocated to a zone of the internal surface of the shell. In this example, the subscriber identity card 30 is likewise relocated to the internal surface of the shell. The electronic entity 10 according to the invention is then designed to interface the NFC device 11, the subscriber identity card 30 and the relocated contacts of the mobile terminal 20.

The steps of a method for managing a transmission of data between a mobile terminal that comprises a subscriber identity card, the subscriber identity card and an NFC device, according to an exemplary embodiment, will now be described with reference to FIG. 3.

The mobile terminal 20, the subscriber identity card 30 and the NFC device 11 are designed to be connected by means of the electronic entity 10 described with reference to FIG. 1. The electronic entity 10 comprises a processing unit 12 that is placed inline on the data transmission path between the mobile terminal 20 and the subscriber identity card 30, firstly, and secondly placed inline on the data transmission path between the mobile terminal 20 and the NFC device 11. The processing unit 12 stores in memory an application according to the invention that comprises code instructions that are intended to prioritize the transmission of the data between the mobile terminal 20, the subscriber identity card 30 and the NFC device 11.

In an initial data interchange step E0, data are interchanged firstly at the first interface I/O₁, that is to say between the mobile terminal 20 and the subscriber identity card 30, and secondly at the second interface I/O₂, that is to say between the mobile terminal and the NFC device 11, or between the mobile terminal 20 and the subscriber identity card 30. By way of example, the mobile terminal 20 commands the installation of an application in the subscriber identity card 30 and transmits the application to be installed through the second interface I/O₂. The application is received by the second memory storage means 122 of the processing unit 12, which transmits these data to the subscriber identity card 30 via the second data link I/O₁₋₂, so long as another priority datum does not arrive.

In a second data interchange step E1, data are interchanged at the first interface I/O₁. By way of example, the mobile terminal wishes to know the state of the network; to this end, it sends a request to the identity card 30 via the first interface I/O₁. The request is received by the processing unit 12 via the first data link I/O₁₋₁ and stored in memory in the first memory storage means 121.

In a prioritization step E2, the processing unit 12 detects the arrival of data on the first interface I/O₁, via the first data link I/O₁₋₁, and prioritizes the transmission of the data according to a given criterion. In a first exemplary embodiment, the criterion consists in giving priority to data interchanged between the mobile terminal 20 and the subscriber identity card 30 at the first data interface I/O₁. Thus, when the second memory storage means 122 comprise data corresponding to a transmission between the mobile terminal 20 and the subscriber identity card 30, or between the mobile terminal 20 and the NFC device 11, these data continue to await processing while the data stored in memory in the first memory storage means 121, corresponding to a transmission between the mobile terminal 20 and the subscriber identity card 30, are forwarded as a matter of priority in the course of a priority transmission step E3.

In an end of transmission step E4, the transmission of the data that has been interrupted by the arrival of priority data is resumed. This transmission resumes when the priority data have all been transmitted. In this example, sending of the application to the subscriber identity card 30 resumes.

Thus, the processing unit 12 organizes the transmission of the data between the mobile terminal 20, the subscriber identity card 30 and the NFC device 11.

In another exemplary embodiment, the criterion used by the processing unit 12 in prioritization step E2 consists in analyzing a code prefixing the data transmitted between the mobile terminal 20 and the subscriber identity card 30 and specifying the type of datum transmitted. By way of example, when the mobile terminal wishes to know whether the network is present, it interrogates the subscriber identity card 30. These interrogation data have a maximum priority and the processing unit 12 transmits these data to the subscriber identity card 30 as a matter of priority in the course of transmission step E3. Thus, the data are organized according to a code prefixing the data and specifying their type.

In the exemplary embodiment described here, a priority is established between data received on the first and second interfaces for the subscriber identity card 30. It will be understood that any type of datum may be the subject of prioritization. Thus, the data transmitted between the mobile terminal 20 and the NFC device 11 are likewise concerned.

The processing unit 12 is adapted to detect the arrival of data on the two interfaces I/O₁ and I/O₂, and to prioritize their transmission.

In the examples described, the data are transmitted from the mobile terminal 20 to the subscriber identity card 30 or to the NFC device 11. The prioritization can likewise apply to the data transmitted from the NFC device 11 or from the subscriber identity card 30 to the mobile terminal 20.

Of course, it will be understood that when just the first or second memory storage means 121, 122 comprise data, these data are transmitted. The reason is that in this case there is no priority to be managed between data.

1. An electronic entity (10) for a mobile terminal (20), said terminal being capable of receiving a subscriber identity card (30), said electronic entity comprising:
a near field communication device (11),
a processing unit (12), placed inline on the data transmission path between the mobile terminal and the subscriber identity card,
a wired interface (120) that is designed to connect the mobile terminal to the near field communication device at a first data interface (I/O₂) by means of the processing unit (12), the processing unit being placed inline on the data transmission path between the mobile terminal and the near field communication device.

2. The electronic entity as claimed in claim 1, in which the wired interface is likewise designed to connect the mobile terminal to the subscriber identity card at a second interface (I/O₁) and the near field communication device to the subscriber identity card by means of a protocol link (SWP), said processing unit being designed to organize at least the data transmitted between the mobile terminal and the subscriber identity card by the first and second data interfaces.

3. The electronic entity as claimed in claim 2, in which the transmission of the data is organized according to an organization criterion.

4. The electronic entity as claimed in claim 2, in which the wired interface is adapted to connect an input/output contact (C7_TM) of the mobile terminal to the processing unit, and the processing unit to an input/output contact (C7_SIM) of the subscriber identity card, so that any datum transmitted between the mobile terminal and the subscriber identity card on the second data interface is received by the processing unit.

5. The electronic entity as claimed in claim 2, in which the wired interface is adapted to connect the processing unit to a connector of the mobile terminal (201) that comprises the first data interface (I/O₂) and to the near field communication device, so that any datum transmitted between the near field communication device and the mobile terminal is received by the processing unit.

6. The electronic entity as claimed in claim 1, in which the wired interface connects the subscriber identity card to the near field communication device by means of a protocol link.

7. The electronic entity as claimed in claim 2, in which the data are organized according to a code prefixing a datum transmitted between the mobile terminal and the subscriber identity card.

8. The electronic entity as claimed in claim 2, in which the processing unit is designed to suspend a transmission of data between the mobile terminal and the subscriber identity card by the first interface on reception of a datum from the mobile terminal for the subscriber identity card on the second interface.

9. The electronic entity as claimed in claim 1, in which the wired interface comprises direct connection means (VCCTM) between an electric power supply output of the mobile terminal and an electric power supply input of the near field communication device.

10. A mobile terminal (20) that is designed to receive a subscriber identity card and comprises an electronic entity (10) for a mobile terminal (20), said terminal being capable of receiving a subscriber identity card (30), said electronic entity comprising:
a near field communication device (11),
a processing unit (12), placed inline on the data transmission path between the mobile terminal and the subscriber identity card,
a wired interface (120) that is designed to connect the mobile terminal to the near field communication device at a first data interface (I/O₂) by means of the processing unit (12), the processing unit being placed inline on the data transmission path between the mobile terminal and the near field communication device.

11. A shell for a mobile terminal, the terminal being capable of receiving a subscriber identity card, the mobile terminal comprising a front face having a user interface and a rear face, said shell comprising an internal surface and an external surface and being adapted to receive the mobile terminal in removable fashion such that the rear face of the mobile terminal is held along the internal surface of the shell, the internal surface of the shell comprising means for holding an electronic entity (10) for a mobile terminal (20), said terminal being capable of receiving a subscriber identity card (30), said electronic entity comprising:
a near field communication device (11),
a processing unit (12), placed inline on the data transmission path between the mobile terminal and the subscriber identity card,
a wired interface (120) that is designed to connect the mobile terminal to the near field communication device at a first data interface (I/O₂) by means of the processing unit (12), the processing unit being placed inline on the data transmission path between the mobile terminal and the near field communication device.

12. A method for managing a transmission of data between a mobile terminal and a near field communication device, the near field communication device being included in an electronic entity (10) for a mobile terminal (20), said terminal being capable of receiving a subscriber identity card (30), said electronic entity comprising:
a near field communication device (11),
a processing unit (12), placed inline on the data transmission path between the mobile terminal and the subscriber identity card,
a wired interface (120) that is designed to connect the mobile terminal to the near field communication device at a first data interface (I/O₂) by means of the processing unit (12), the processing unit being placed inline on the data transmission path between the mobile terminal and the near field communication device, wherein the wired interface is likewise designed to connect the mobile terminal to the subscriber identity card at a second interface (I/O₁) and the near field communication device to the subscriber identity card by means of a protocol link (SWP), said processing unit being designed to organize at least the data transmitted between the mobile terminal and the subscriber identity card by the first and second data interfaces,
said entity being placed inline between the mobile terminal and the subscriber identity card, said method comprising:
a step (E0) of reception of first data on a first data interface (I/O₁),
a step (E1) of reception of second data on a second data interface (I/O₂),
a step (E2) of prioritization of the transmission of said first and second data according to an organization criterion,
a step (E3, E4) of transmission of said first and second data, according to the defined organization.

13. A program on a data storage medium and that can be loaded into a memory of an electronic entity, the program comprising code portions for executing steps of a method for managing a transmission of data between a mobile terminal and a near field communication device, the near field communication device being included in an electronic entity (10) for a mobile terminal (20), said terminal being capable of receiving a subscriber identity card (30), said electronic entity comprising:
a near field communication device (11),
a processing unit (12), placed inline on the data transmission path between the mobile terminal and the subscriber identity card,
a wired interface (120) that is designed to connect the mobile terminal to the near field communication device at a first data interface (I/O₂) by means of the processing unit (12), the processing unit being placed inline on the data transmission path between the mobile terminal and the near field communication device, wherein the wired interface is likewise designed to connect the mobile terminal to the subscriber identity card at a second interface (I/O₁) and the near field communication device to the subscriber identity card by means of a protocol link (SWP), said processing unit being designed to organize at least the data transmitted between the mobile terminal and the subscriber identity card by the first and second data interfaces,
said entity being placed inline between the mobile terminal and the subscriber identity card, said method comprising:
a step (E0) of reception of first data on a first data interface (I/O₁),
a step (E1) of reception of second data on a second data interface (I/O₂),
a step (E2) of prioritization of the transmission of said first and second data according to an organization criterion,
a step (E3, E4) of transmission of said first and second data, according to the defined organization.

14. A data storage medium on which a program is recorded the program can be loaded into a memory of an electronic entity, the program comprising code portions for executing steps of a method for managing a transmission of data between a mobile terminal and a near field communication device, the near field communication device being included in an electronic entity (10) for a mobile terminal (20), said terminal being capable of receiving a subscriber identity card (30), said electronic entity comprising:
a near field communication device (11),
a processing unit (12), placed inline on the data transmission path between the mobile terminal and the subscriber identity card,
a wired interface (120) that is designed to connect the mobile terminal to the near field communication device at a first data interface (I/O₂) by means of the processing unit (12), the processing unit being placed inline on the data transmission path between the mobile terminal and the near field communication device, wherein the wired interface is likewise designed to connect the mobile terminal to the subscriber identity card at a second interface (I/O₁) and the near field communication device to the subscriber identity card by means of a protocol link (SWP), said processing unit being designed to organize at least the data transmitted between the mobile terminal and the subscriber identity card by the first and second data interfaces,
said entity being placed inline between the mobile terminal and the subscriber identity card, said method comprising:
a step (E0) of reception of first data on a first data interface (I/O₁),
a step (E1) of reception of second data on a second data interface (I/O₂),
a step (E2) of prioritization of the transmission of said first and second data according to an organization criterion,
a step (E3, E4) of transmission of said first and second data, according to the defined organization.

15. The electronic entity as claimed in claim 3, in which the wired interface is adapted to connect an input/output contact (C7_TM) of the mobile terminal to the processing unit, and the processing unit to an input/output contact (C7_SIM) of the subscriber identity card, so that any datum transmitted between the mobile terminal and the subscriber identity card on the second data interface is received by the processing unit.

16. The electronic entity as claimed in claim 3, in which the wired interface is adapted to connect the processing unit to a connector of the mobile terminal (201) that comprises the first data interface (I/O₂) and to the near field communication device, so that any datum transmitted between the near field communication device and the mobile terminal is received by the processing unit.

17. The electronic entity as claimed in claim 4, in which the wired interface is adapted to connect the processing unit to a connector of the mobile terminal (201) that comprises the first data interface (I/O₂) and to the near field communication device, so that any datum transmitted between the near field communication device and the mobile terminal is received by the processing unit.
